(19) United States
(12) Patent Application Publication
(10) Pub. No.: US 2005/0170201 A1
(43) Pub. Date: Aug. 4, 2005

(54) Cobalt-phosphorous-boron coating and process for plating

(75) Inventors: Michael H.E. Ware, Renton, WA (US); Luong M. Tran, Tacoma, WA (US); James E. Skilton, Seattle, WA (US)

Correspondence Address: SHIMOKAJI & ASSOCIATES, P.C., 8911 RESEARCH DRIVE, IRVINE, CA, 92618, US

(73) Assignee: The Boeing Company, Chicago, IL (US)

(21) Appl. No.: 10/772,683

(22) Filed: Feb. 4, 2004

(51) Int. Cl. B32B 15/00; C25D 3/56; C25D 5/10

(52) U.S. Cl. 428/668; 428/935; 106/1.27; 205/258

(57) ABSTRACT

A cobalt-phosphorous-boron coating and a process for plating that is environmentally acceptable are provided. Furthermore, a cobalt-phosphorous plating solution is provided to deposit the cobalt-phosphorous-boron coating during the plating process on a surface of an article of manufacture. The cobalt-phosphorous plating solution does not contain chemicals presently restricted in use by the EPA. The cobalt-phosphorous-boron coating is a wear resistant coating with engineering properties, for example, low compressive residual stress, excellent adhesion to ferrous and nickel alloys, low fatigue debit, and a corrosion resistant crack-free structure, that meet or exceed the engineering properties of hard chromium plating intended for use in the aerospace industry. Furthermore, the cobalt-phosphorous plating process uses facilities and equipment that are comparable to those of the chromium plating process, and therefore, may be easily, readily, and economically introduced and implemented, for example, in the aerospace industry.

### BACKGROUND OF THE INVENTION

The present invention generally relates to wear resistant coatings and electroplating processes and, more particularly, to a cobalt-phosphorous-boron coating and to a cobalt-phosphorous plating process.

Chromium plating has been used for many years to apply a wear resistant coating to ferrous and nickel alloys. Currently, chromium plating is used in the aerospace industry to apply a tough wear resistant coating on parts such as landing gear parts, pistons, pins, hooks, and other types of parts that are severely loaded, have sliding surfaces or could experience impact during service. Chromium plating is one of the most widely used processes to apply wear resistant coatings in the aerospace industry, and many plating shops perform this operation routinely. However, the EPA has issued limits on air pollution caused by chromium as well as tightened the limits for chromium in the water. Furthermore, the process for depositing the chromium is a hazardous process. The plating solution generates large amounts of fumes during the chromium plating process that may go on for several hours. These fumes are considered toxic to the shop personnel since the fumes contain hexavalent chromium, which is a suspected carcinogen. Occupational worker regulations now require expensive emission controls, which include anti-mist chemicals, vent ducts, and fume scrubbers.

Furthermore, from an engineering standpoint, chromium plate falls short in several requirements. Micro cracks in the coating allow for moisture ingress, which severely reduces corrosion resistance on, for example, alloy steel. These micro cracks also reduce fatigue life, since they serve as initiation sites for cracks that will extend into the base metal. And finally, both high coating stresses and the solution's strong oxidizing environment leads to a high risk of poor coating adhesion.

The aerospace industry has implemented some replacement processes for chromium plating. These prior art processes include, for example, the application of high velocity oxygen fuel (HVOF) thermal spray coatings, composite electroplating, and electroless deposition. Even though HVOF thermal spray coatings meet or surpass the engineering properties of chromium plate, their application is limited to line-of-sight applications, i.e. 1:1 width-to-depth ratios, often called aspect ratios. Blind holes, for example, cannot be coated using this technology. The application of composite coatings, which incorporates hard particulates, requires costly facility modifications to keep the particles continuously in suspension during processing. Finally, bath stability issues and adhesion failures on critical hardware restrict the use of electroless coatings on commercial aircraft.

Furthermore, “Integran Technology”, Toronto, Canada, has developed a nanophase electroplating technology that uses pulse electroplating to deposit a cobalt alloy on a substrate. This technology requires plating equipment that is different from the existing chromium plating equipment and, therefore, requires costly modifications of the existing facilities. Also, the area that can be plated using the nanophase technology is limited by the maximum-pulsed current capability of the power supply. Furthermore, high tensile residual stresses in the coating will cause an unacceptable debit in fatigue life.

There has, therefore, arisen a need to replace the chromium plating process with a plating process that does not produces hazardous fumes containing hexavalent chromium. There has further arisen a need to replace the chromium plate with a wear resistant coating that does not contain chromium and that meets or exceeds the engineering properties of the chromium plate. There has still further arisen a need to provide a plating process that enables the plating of all desired surfaces including non line-of-sight applications, for example, blind holes. There has still further arisen a need to provide a plating process that uses the same facilities and equipment as the chromium plating process in order to keep the costs of implementing a new technology as low as possible.

As can be seen, there is a need for a wear resistant coating that meets the engineering requirements of aircraft wear resistant coatings and that can replace chromium plate. There is a further need to provide a process for plating that is free of hexavalent chromium. Furthermore, there is a need to provide a process for plating that replaces the chromium plating process but may use the existing facilities and equipment.

### SUMMARY OF THE INVENTION

The present invention provides a plating process that is free of hexavalent chromium and that enables the application of a wear resistant coating that meets or exceeds the engineering properties of chromium plate. The present invention further provides a plating process that uses the same facilities and equipment as the chromium plating process. The present invention still further provides a wear resistant coating and a plating process for application of this coating to various substrates that is suitable for, but not limited to, the aerospace industry.

In one aspect of the present invention, an article of manufacture includes a substrate having a surface and a cobalt-phosphorous-boron coating applied to the surface.

In another aspect of the present invention, an article of manufacture includes a substrate having a surface and a cobalt-phosphorous-boron coating applied to the surface. The cobalt-phosphorous-boron coating contains cobalt in the range of about 80 to 90 weight percent, phosphorous in the range of about 10 to 15 weight percent, and a maximum of about 5 weight percent boron.

In still another aspect of the present invention, a plating bath includes a plating solution, cobalt metal ions, chloride ions, phosphorous ions, an oxidizing agent, and a hardening agent. The cobalt metal ions, the chloride ions, the phosphorous ions, the oxidizing agent, and the hardening agent are contained within the plating solution.

In still another aspect of the present invention, a cobalt-phosphorous plating solution includes cobalt sulfate (COSO₄.6H₂O) within a range of about 20 to 26 oz/gal, sodium chloride (NaCl) within a range of about 2 to 3.5 oz/gal, boron as perborate within a range of about 1.6 to 2.6 oz/gal, phosphite as phosphorous acid (H₃PO₃) within a range of about 1.6 to 2.6 oz/gal, and phosphate as phosphoric acid (H₃PO₄) within a range of about 7 to 9 oz/gal. The cobalt sulfate, the sodium chloride, the perborate, the phosphorous acid, and the phosphoric acid are combined in tanks.

In still another aspect of the present invention, a process for plating includes the steps of: providing an article of manufacture including a substrate having a surface; cleaning and preparing the surface during a pretreatment process; applying a cobalt-phosphorous-boron coating to the surface during a cobalt-phosphorous plating process; and finishing the surface during a post treatment process.

In a further aspect of the present invention, a process for plating an article of manufacture used in the aerospace industry includes the steps of: providing a part of a commercial aircraft including a substrate having a surface to be plated; degreasing the surface of the part; masking areas of the surface not to be plated; cleaning the surface using dry abrasive blast; alkaline cleaning the surface; acid activating the surface; providing a cobalt-phosphorous plating solution; providing a platinized metal anode and submerging the anode into the cobalt-phosphorous plating solution; submerging the part into the cobalt-phosphorous plating solution; applying direct current that generates a cathode current density in the range of about 60 to 288 Amps/f²; plating the surface of the part with a cobalt-phosphorous-boron coating; demasking the surface; baking the part having the cobalt-phosphorous-boron coating applied within 8 hours of application of the coating; and using the part having the cobalt-phosphorous-boron coating in a commercial aircraft. The cobalt-phosphorous plating solution comprises: cobalt sulfate (CoSO₄.6H₂O) within a range of about 20 to 26 oz/gal; sodium chloride (NaCl) within a range of about 2 to 3.5 oz/gal; boron as perborate within a range of about 1.6 to 2.6 oz/gal; phosphite as phosphorous acid (H₃PO₃) within a range of about 1.6 to 2.6 oz/gal; and phosphate as phosphoric acid (H₃PO₄) within a range of about 7 to 9 oz/gal. The cobalt-phosphorous-boron coating comprises: cobalt in the range of about 80 to 90 weight percent; phosphorous in the range of about 10 to 15 weight percent; and about 5 weight percent boron maximum.

These and other features, aspects and advantages of the present invention will become better understood with reference to the following drawings, description and claims.

### BRIEF DESCRIPTION OF THE DRAWINGS

FIG. 1 is a schematic cross sectional view of an article of manufacture according to one embodiment of the present invention; and

FIG. 2 is a flow chart of a process for plating according to one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, an embodiment of the present invention provides a cobalt-phosphorous-boron coating that may be used to replace the chromium plate that is currently commonly used as a wear protective coating, for example in the aerospace industry. The cobalt-phosphorous-boron coating as in one embodiment of the present invention meets the engineering requirements of aircraft wear coatings. The cobalt-phosphorous-boron coating furthermore meets or exceeds the engineering properties of prior art chromium plate. Therefore, the cobalt-phosphorous-boron coating may be applied to aircraft parts that are severely loaded, have sliding surfaces, or could experience impact during service, such as landing gear parts, pistons, shafts, pins, and hooks. An embodiment of the present invention further provides a process for cobalt-phosphorous plating that may be used to replace the chromium plating process that is currently commonly used to apply chromium plate to a substrate, such as ferrous and nickel alloys. By providing a cobalt-phosphorous plating process for application of a cobalt-phosphorous-boron coating to various substrates, the use of chromium, which is a chemical that is limited in use by the EPA, can be eliminated. By eliminating chromium from the plating solution, as in one embodiment of the present invention, fumes containing hexavalent chromium, a suspected carcinogen, will not be produced, in contrast to typical prior art processes using chromium. Furthermore, the cobalt-phosphorous plating process according to one embodiment of the present invention does not require major facility modification that might be expensive. The cobalt-phosphorous plating process may use the same and already existing facilities and equipment that are used for the prior art chromium plating process.

In one embodiment, the present invention provides a cobalt-phosphorous-boron coating that is bright, ductile, dense, and free of cracks, and therefore, exceeds the engineering properties of prior art chromium plate. The cobalt-phosphorous-boron coating further possesses sufficient hardness to meet wear and fatigue requirements, meeting the engineering properties of prior art chromium plate. The increased ductility, substrate adhesion, and corrosion resistance of the cobalt-phosphorous-boron coating compared to the prior art chromium plate will extend the life of parts that need to be repaired or scrapped often, such as flap track carriage spindles.

An embodiment of the present invention further provides a cobalt-phosphorous plating process that uses a plating solution having a simple composition. By combining cobalt sulfate, sodium chloride, boron, phosphite, and phosphate in the plating solution, no chemicals that are restricted in use by the EPA are used. Therefore, the cobalt-phosphorous plating process is an environmentally acceptable process. Further, contrary to the prior art chromium plating process, no fumes that are hazardous to the health of the shop personnel will be produced. Also, the cobalt-phosphorous plating process as in one embodiment of the present invention, may replace the prior art sulfamate nickel repair of damaged or corroded areas, eliminating a further chemical element restricted in use by the EPA. Furthermore, the cobalt-phosphorous plating process allows the application of the cobalt-phosphorous-boron coating as in one embodiment of the present invention to all desired surfaces, including, for example, blind holes. Contrary to the prior art HVOF thermal spray coatings, cobalt-phosphorous-boron coatings are not limited to line-of-sight applications. A higher plating rate at a lower current density compared to prior art chromium plating is achievable with the cobalt-phosphorous plating process as in one embodiment of the present invention. Therefore, the cobalt-phosphorous plating process is more efficient than the prior art chromium plating process.

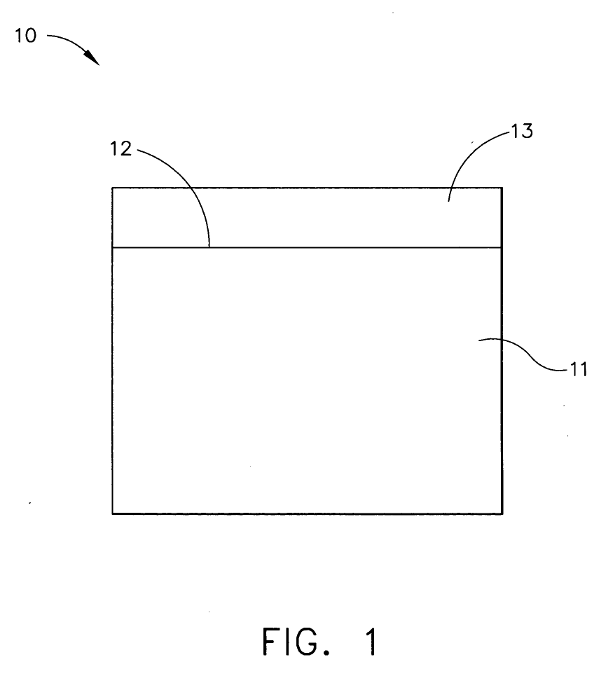

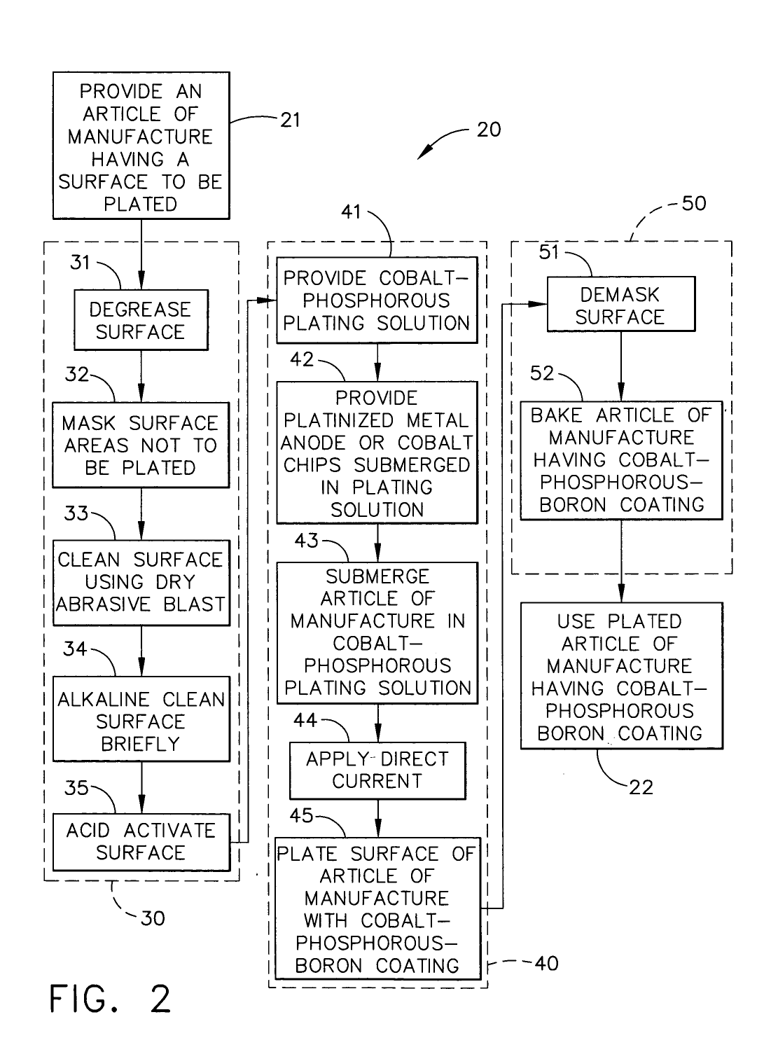

Referring now to FIG. 1, an article of manufacture 10 is illustrated in a schematic cross sectional view according to one embodiment of the present invention. The article of manufacture 10 includes a substrate 11 having a surface 12 and a cobalt-phosphorous-boron coating 13. The cobalt-phosphorous-boron coating 13 may be applied to the surface 12 during a cobalt-phosphorous plating process 40, as shown in FIG. 2. The article of manufacture 10 may be a part of a commercial aircraft that is severely loaded, has sliding surfaces, or could experience impact during service, for example, a landing gear part, a piston, a shaft, a pin, and a hook. The article of manufacture 10 may be used, for example, in the aerospace industry.

The substrate 11 of the article of manufacture 10 may have a catalytically active surface. Suitable substrates 11 may be composed, for example, of nickel, cobalt, iron, steel, aluminum, zinc, palladium, platinum, copper, brass, chromium, tungsten, titanium, tin, silver carbon, graphite and alloys thereof. Preferred substrates for the application of the cobalt-phosphorous-boron coating 13 include ferrous and nickel base alloys.

Referring now to FIG. 2, a process for plating 20 is illustrated in a simplified flow chart according to one embodiment of the present invention. The process for plating 20 may include a step 21, a pretreatment process 30, a cobalt-phosphorous plating process 40, a post treatment process 50, and a step 22. The article of manufacture 10 having a surface 12 to be plated with a wear resistant coating 13 may be provided in step 21. During the pretreatment process 30, the surface 12 of the article of manufacture 10 provided in step 21 may be cleaned and prepared for the cobalt-phosphorous plating process 40. During the cobalt-phosphorous plating process 40 the surface 12 of the article of manufacture 10 provided in step 21 may be plated with a cobalt-phosphorous-boron coating 13. The cobalt-phosphorous-boron coating 13 meets the engineering requirements for aircraft wear coatings. During the post treatment process 50, the plated article of manufacture 10 will be prepared for its application in the industry by finishing the cobalt-phosphorous-boron coating 13. Finally, in step 22, the plated article of manufacture 10 may be built into, for example, a commercial aircraft.

The pretreatment process 30 may include steps 31, 32, 33, 34, and 35. In step 31, the surface 12 of the article of manufacture 10 provided in step 21 may be degreased. The degreasing of the surface 12 may be done, for example, by vapor degrease, solvent wipe, or aqueous degrease. The solvent wipe, where the surface 12 may be wiped with solvents such as ketones, alcohols or similar solvents, may be used preferably for smaller articles of manufacture 10. An aqueous degreaser may be used to degrease the surface 12 of larger articles of manufacture 10. The aqueous degreaser may be applied to the surface 12 in step 31 either by spraying onto the surface 12 or by immersion of the surface 12 into the aqueous degreaser.

Surface areas of the surface 12 that should not receive a wear resistant coating may be masked in step 32. For example, lacquers, rubber-based coatings, and tapes composed of vinyl, Teflon or lead are typical materials that may be used to mask surface areas of the surface 12 in step 32. If the configuration of the article of manufacture 10 allows, rubber boots may also be used in step 32 to mask areas of the surface 12 that should not be coated. After application of a mask in step 32, the surface 12 of the article of manufacture 10 may be cleaned in step 33 using a dry abrasive blast. An abrasive material such as glass bead or aluminum oxide having a grit in the range of about 80 to 220 may be blasted onto the surface 12 at about 60 psi in step 33, for example. In step 34, a brief alkaline cleaning may follow the dry abrasive blast cleaning of step 33 to ensure a thoroughly cleaned surface 12. The cleaning process of step 34 may be an electrolytic process requiring the use of a rectifier as a power supply. The article of manufacture 10 may be immersed in an alkaline electrolyte solution and may be hooked as cathode. Furthermore inert anodes may be used. Once the circuit is closed a cathodic (plating) cycle may be started. The cathodic cycle may alternate with an anodic (de-plating) cycle for about 5 to 10 minutes ending with the anodic cycle. Following the cleaning of the surface 12 in steps 31, 32, 33, and 34, the surface 12 of the article of manufacture 10 provided in step 21 might be acid activated in step 35. During step 35 the surface 12 may be immersed in an immersion solution for about 5 to 60 seconds. The process flow, as in steps 31, 32, 33, 24, and 35 of the pretreatment process 30 illustrated in FIG. 2, may be just one of many possible routes. The process flow of the pretreatment process 30 may be adjusted dependent on the material of the substrate 11, for example, low and high strength alloy steels, copper alloys, aluminum alloys, and nickel base alloys, as well as the heat treat of the substrate 11. The steps 31, 32, 33, 34, and 35 of the pretreatment process may be comparable to the pretreatment steps of a prior art chromium plating process. Therefore, existing facilities and equipment may be used for steps 31, 32, 33, 34, and 35 keeping the costs of implementing the process of plating 20 relatively low.

The cobalt-phosphorous plating process 40 may include the steps 41, 42, 43, 44, and 45. A cobalt-phosphorous plating solution may be provided in step 41 for the cobalt-phosphorous plating process 40. The cobalt-phosphorous plating solution may be provided as a plating bath in relatively large tanks. The cobalt-phosphorous plating solution may include the following components: cobalt metal ions, chloride ions, phosphorous ions, an oxidizing agent, and a hardening agent. The cobalt-phosphorous plating solution may have the following composition: cobalt sulfate as CoSO₄.6H₂O with a preferred range of 20 to 26 oz/gal; sodium chloride as NaCl with a preferred range of 2 to 3.5 oz/gal; boron as perborate with a preferred range of 1.6 to 2.6 oz/gal; phosphite as phosphorous acid (H₃PO₃) with a preferred range of 1.6 to 2.6 oz/gal, and phosphate as phosphoric acid (H₃PO₄) with a preferred range of 7 to 9 oz/gal. The preferred range for the cobalt metal content of the cobalt-phosphorous plating solution is 4.4 to 5.8 oz/gal. The preferred range for the pH value of the cobalt-phosphorous plating solution is 1 to 1.6, but a range from 0 to 2 for the pH value may be possible. The surface tension of the cobalt-phosphorous plating solution having above described composition may be in a preferred range of 35 to 50 dyne/cm. The preferred temperature of the cobalt-phosphorous plating solution is 130 to 140 F, but a range of 110 to 170 F may be possible. The cobalt sulfate may be a source for the cobalt metal ions in the cobalt-phosphorous plating solution, although other cobalt salts such as (but not limited to) citrate, phosphate, carbonate, and chloride may be used. Cobalt chips or balls submerged in the cobalt-phosphorous plating solution may also be used as a source for the cobalt metal ions. The sodium chloride provides needed conductivity of the cobalt-phosphorous plating solution and may help to maintain the low compressive residual stress of the wear resistant coating that may be applied to the surface 12 of the article of manufacture 10 in step 45. Other chloride sources such as cobalt chloride and ammonium chloride may be used, but these may cause an unacceptable level of tensile residual stress in the coating. Boron may be added to the cobalt-phosphorous plating solution as an oxidizing agent that allows for a high deposit quality over a wider plating range. Boron may further act as a catalyst that improves the bright deposition range by producing fine-grained deposits over a wider range of process variables such as current density and temperature. The preferred chemical that may be added to the cobalt-phosphorous plating solution to provide boron is perborate, but boric acid or other borate compounds may also be used. Phosphite may be added to the cobalt-phosphorous plating solution as a hardening agent that provides a certain hardness of the wear resistant coating that may be applied to the surface 12 of the article of manufacture 10 in step 45. Instead of phosphorous acid, the preferred chemical added to the plating solution to provide phosphite, sodium phosphite or sodium hypophosphite might be used as a hardening agent. Phosphate may be added to the cobalt-phosphorous plating solution to provide the conductivity of the plating solution, to provide for phosphate/phosphite equilibrium, and to maintain the pH value of the plating solution within a certain range. Instead of phosphoric acid, the preferred chemical added to the plating solution to provide phosphate, cobalt phosphate or sodium phosphate might be used. The cobalt-phosphorous plating solution may be designed to be used in large volumes for long time periods without the need for frequent tank dumps or draw offs to maintain the bath chemistry within limits. Since cobalt metal ions and phosphorous ions may deplete in a constant ratio during the plating process of step 35, only minor additions and solution draw offs may be necessary for long-term maintenance. In some circumstances, stress reducers based on sulfur compounds such as sodium saccharin may be added to increase the hardness and increase the compressive stress.

In step 42, an anode may be provided for the cobalt-phosphorous plating process 40. The anode may be a platinized metal anode submerged in the cobalt-phosphorous plating solution that may be provided in step 41. The anode provided in step 42 may further consist of cobalt chips or balls. The cobalt chips or balls may be placed in a basket and then submerged in the cobalt-phosphorous plating solution. If cobalt chips or balls are used as an anode in the cobalt-phosphorous plating process 40 instead of the platinized metal anode, it might not be necessary to add cobalt sulfate or other cobalt salt to the cobalt-phosphorous plating solution as described in step 41. The cobalt chips or balls will dissolve slowly in the cobalt-phosphorous plating solution and provide cobalt metal ions to the plating solution.

After providing the cobalt-phosphorous plating solution in step 41 and the anode in step 42, the article of manufacture 10 provided in step 21 may be submerged in the cobalt-phosphorous plating solution in step 43, as shown in FIG. 2. Now a direct current may be applied between the cathode and the anode in step 44. The article of manufacture 10 provided in step 21 may act as the cathode having a cathode current density. The direct current may be chosen to generate a cathode current density in a preferred range of about 60 Amps/ft² to about 288 Amps/ft². It may be possible to apply a pulse current to the plating solution instead of using direct current.

With the application of a direct current in step 44, the plating of the surface 12 of the article of manufacture 10 submerged in the cobalt-phosphorous plating solution may be started. In step 45, the surface 12 may be plated with a cobalt-phosphorous-boron coating 13. The cobalt-phosphorous-boron coating 13 may be a wear resistant coating having the following composition: cobalt with a preferred range of 80 to 90 weight percent; phosphorous with a preferred range of 10 to 15 weight percent; and boron with a maximum of 5 weight percent. The cobalt-phosphorous-boron coating 13 may be deposited on all surfaces 12 of the article of manufacture 10 submerged in the cobalt-phosphorous plating solution including non line-of-sight areas, such as blind holes. The thickness of the cobalt-phosphorous-boron coating 13 applied to the surface 12 in step 45 may be adjusted depending on the time period over which the direct current is applied. The cobalt-phosphorous-boron coating 13 may be deposited on the surface at a plating rate of about 0.001 inch/hr to about 0.005 inch/hr. Therefore, the cobalt-phosphorous plating process 40, as shown in FIG. 2, may have a faster plating rate compared to the plating rate of the prior art chromium plating process, which is about 0.0005 inch/hr at 140 F. By using the cobalt-phosphorous plating process 40, a cobalt-phosphorous-boron coating 13 may be obtained in step 45 that is ductile, free of cracks, and possesses sufficient hardness and compressive residual stress properties to meet wear and fatigue requirements for aircraft wear coatings. Further, the cobalt-phosphorous-boron coating 13 may have an improved corrosion resistance compared with prior art chromium plate. The composition of the cobalt-phosphorous plating solution provided in step 41 may provide an improved surface adhesion of the cobalt-phosphorous-boron coating 13 compared to prior art chromium plating.

The post treatment process 50 may include the steps 51 and 52, as shown in FIG. 2. After the cobalt-phosphorous-boron coating 13 was applied to the surface 12 of the article of manufacture 10 in step 45, the mask may be removed from the surface 12 in step 51. The tape applied to surface areas of the surface 12 in step 32 may be peeled off in step 51. Furthermore, if a rubber boot was used to cover areas of the surface 12 in step 32 it may be taken off in step 51. After additional rinsing that may be required to remove any residual chemical trapped underneath the maskant, the article of manufacture 10 may be ready to be baked in step 52. The baking in step 52 may be performed in an oven at a temperature in the preferred range of about 375 F+/−25 F, although this can vary due to substrate heat treatment. The duration of the baking may vary from about 3 hours to about 23 hours depending on the strength level of the substrate 11, regardless of the thickness of the cobalt-phosphorous-boron coating 13. The baking in step 52 shall follow, within 8 hours, the step 45 where the coating 13 is applied to the surface 12. The article of manufacture 10 may now be ready for application in the industry without any additional grinding or polishing. In other cases, the cobalt-phosphorous-boron coating 13 may require additional grinding or polishing to proper thickness (i.e. grinding to size) prior to its industry application. The post treatment process 50 may be comparable to the post treatment process of the prior art chromium plating process. Therefore, the already existing equipment and facilities may be used for the post treatment process 50. The article of manufacture 10 having a cobalt-phosphorous-boron plated surface 12 may now be ready for use in, for example, a commercial aircraft, as shown in step 22.

By providing a cobalt-phosphorous-boron coating 13 that may be applied to a surface 12 of an article of manufacture 10 (as in step 45) using the cobalt-phosphorous plating process 40, the prior art chromium plating solution may be eliminated improving the safety of the shop personnel by reduction of toxic fumes. Furthermore, by eliminating chemicals which use is restricted by the EPA, such as chromium, from the wear resistant coating as well as the plating process 20, an environmentally friendly wear resistant coating, the cobalt-phosphorous-boron coating 13, applied to a surface 12 in an environmentally friendly plating process 20 may be provided. By providing the cobalt-phosphorous plating process 40 that has a faster plating rate than the prior art chromium plating process, the operation flow time may be reduced. Also, by providing a cobalt-phosphorous-boron coating 13 having improved engineering properties compared to the prior art chromium plate and by providing a process for plating 20 that may use the already existing equipment and facilities of the chromium plating process, the cobalt-phosphorous-boron coating 13 may economically replace the prior art chromium plate.

It should be understood, of course, that the foregoing relates to preferred embodiments of the invention and that modifications may be made without departing from the spirit and scope of the invention as set forth in the following claims.

1. An article of manufacture, comprising:
a substrate having a surface; and
a cobalt-phosphorous-boron coating applied to said surface.

2. The article of manufacture of claim 1, wherein said cobalt-phosphorous-boron coating contains cobalt in the range of about 80 to 90 weight percent.

3. The article of manufacture of claim 1, wherein said cobalt-phosphorous-boron coating contains phosphorous in the range of about 10 to 15 weight percent.

4. The article of manufacture of claim 1, wherein said cobalt-phosphorous-boron coating contains a maximum of about 5 weight percent boron.

5. The article of manufacture of claim 1, wherein said cobalt-phosphorous-boron coating is applied to non line-of-sight areas of said surface.

6. The article of manufacture of claim 1, wherein said cobalt-phosphorous-boron coating is ductile.

7. The article of manufacture of claim 1, wherein said cobalt-phosphorous-boron coating is free of micro cracks.

8. The article of manufacture of claim 1, wherein said cobalt-phosphorous-boron coating provides good surface adhesion.

9. An article of manufacture, comprising:
a substrate having a surface; and
a cobalt-phosphorous-boron coating applied to said surface;
wherein said cobalt-phosphorous-boron coating contains cobalt in the range of about 80 to 90 weight percent, phosphorous in the range of about 10 to 15 weight percent, and a maximum of about 5 weight percent boron.

10. The article of manufacture of claim 9, wherein said substrate is selected from the group of nickel, cobalt, iron, steel, aluminum, zinc, palladium, platinum, copper, brass, chromium, tungsten, titanium, tin, silver carbon, graphite, and alloys thereof.

11. The article of manufacture of claim 9, wherein said substrate is selected from the group of ferrous alloys, nickel alloys, copper alloys, and aluminum alloys.

12. The article of manufacture of claim 9, wherein said article of manufacture is a part of a commercial aircraft.

13. A plating bath, comprising:
a plating solution;
cobalt metal ions contained within said plating solution;
chloride ions contained within said plating solution;
phosphorous ions contained within said plating solution;
an oxidizing agent contained within said plating solution; and
a hardening agent contained within said plating solution.

14. The plating bath of claim 13, wherein said cobalt metal ions, said chloride ions, said phosphorous ions, said oxidizing agent, and said hardening agent form a cobalt-phosphorous plating solution.

15. The plating bath of claim 13, wherein the cobalt metal content of said plating solution is in the range of about 4.4 to 5.8 oz/gal.

16. The plating bath of claim 13, wherein a source of said cobalt metal ions includes cobalt sulfate and other cobalt salts.

17. The plating bath of claim 13, wherein cobalt chips submerged in said plating solution is the source of said cobalt metal ions.

18. The plating bath of claim 13, wherein cobalt balls submerged in said plating solution is the source of said cobalt metal ions.

19. The plating bath of claim 13, wherein a source of said chloride ions includes sodium chloride and other chloride compounds.

20. The plating bath of claim 13, wherein boron comprises said oxidizing agent.

21. The plating bath of claim 20, wherein perborate provides said boron.

22. The plating bath of claim 20, wherein boric acid and other boron compounds provide said boron.

23. The plating bath of claim 13, wherein phosphite comprises said hardening agent.

24. The plating bath of claim 23, wherein phosphorous acid provides said phosphite.

25. The plating bath of claim 23, wherein sodium phosphite and sodium hypophosphite provide said phosphite.

26. The plating bath of claim 13, wherein said plating solution contains phosphate.

27. The plating bath of claim 26, wherein said phosphate is selected from the group of phosphoric acid, cobalt phosphate, and sodium phosphate.

28. A cobalt-phosphorous plating solution, comprising:
cobalt sulfate (CoSO₄.6H₂O) within a range of about 20 to 26 oz/gal;
sodium chloride (NaCl) within a range of about 2 to 3.5 oz/gal;
boron as perborate within a range of about 1.6 to 2.6 oz/gal;
phosphite as phosphorous acid (H₃PO₃) within a range of about 1.6 to 2.6 oz/gal; and
phosphate as phosphoric acid (H₃PO₄) within a range of about 7 to 9 oz/gal;
wherein said cobalt sulfate, said sodium chloride, said perborate, said phosphorous acid, and said phosphoric acid are combined in tanks.

29. The cobalt-phosphorous plating solution of claim 28, wherein said cobalt-phosphorous plating solution has a pH range of about 1 to 1.6.

30. The cobalt-phosphorous plating solution of claim 28, wherein said cobalt-phosphorous plating solution has a pH range of about 0 to 2.

31. The cobalt-phosphorous plating solution of claim 28, wherein said cobalt-phosphorous plating solution has a surface tension of about of 35 to 50 dyne/cm.

32. The cobalt-phosphorous plating solution of claim 28, wherein said cobalt-phosphorous plating solution has a temperature of about 110 to 170 F.

33. The cobalt-phosphorous plating solution of claim 28, wherein an anode and a cathode are submerged into said cobalt-phosphorous plating solution, and wherein said anode is a platinized metal anode, and wherein said cathode is an article of manufacture having a surface to be plated.

34. The cobalt-phosphorous plating solution of claim 33, wherein said anode comprises cobalt chips and cobalt balls.

35. The cobalt-phosphorous plating solution of claim 28, wherein a direct current is applied that generates a cathode current density in the range of about 60 to 288 Amps/f².

36. A process for plating, comprising the steps of:
providing a substrate having a surface;
cleaning and preparing said surface during a pretreatment process;
applying a cobalt-phosphorous-boron coating to said surface during a cobalt-phosphorous plating process; and
finishing said surface during a post treatment process.

37. The process for plating of claim 36, wherein said substrate has a catalytically active surface.

38. The process for plating of claim 36, wherein said pretreatment process comprises the steps of:
degreasing said surface;
masking areas of said surface not to be plated;
cleaning said surface using dry abrasive blast;
alkaline cleaning said surface; and
acid activating said surface.

39. The process for plating of claim 36, wherein said cobalt-phosphorous plating process comprises the steps of:
providing a cobalt-phosphorous plating solution;
providing an anode and submerging said anode into said cobalt-phosphorous plating solution;
submerging said surface into said cobalt-phosphorous plating solution;
applying direct current; and
plating said surface with said cobalt-phosphorous-boron coating.

40. The process for plating of claim 36, wherein said post treatment process comprises the steps of:
demasking said surface; and
baking said surface having said cobalt-phosphorous-boron coating applied.

41. A process for plating an article of manufacture used in the aerospace industry, comprising the steps of:
providing a part of a commercial aircraft including a substrate having a surface to be plated;
degreasing said surface of said part;
masking areas of said surface not to be plated;
cleaning said surface using dry abrasive blast;
alkaline cleaning said surface;
acid activating said surface;
providing a cobalt-phosphorous plating solution, wherein said cobalt-phosphorous plating solution comprises:
cobalt sulfate (CoSO₄.6H₂O) within a range of about 20 to 26 oz/gal;
sodium chloride (NaCl) within a range of about 2 to 3.5 oz/gal;
boron as perborate within a range of about 1.6 to 2.6 oz/gal;
phosphite as phosphorous acid (H₃PO₃) within a range of about 1.6 to 2.6 oz/gal; and
phosphate as phosphoric acid (H₃PO₄) within a range of about 7 to 9 oz/gal;
providing a platinized metal anode and submerging said anode into said cobalt-phosphorous plating solution;
submerging said part into said cobalt-phosphorous plating solution;
applying direct current that generates a cathode current density in the range of about 60 to 288 Amps/f²;
plating said surface of said part with a cobalt-phosphorous-boron coating, wherein said cobalt-phosphorous-boron coating comprises:
cobalt in the range of about 80 to 90 weight percent;
phosphorous in the range of about 10 to 15 weight percent; and
a maximum of about 5 weight percent boron;
demasking said surface;
baking said part having said cobalt-phosphorous-boron coating applied within 8 hours of application of said coating; and
using said part having said cobalt-phosphorous-boron coating in a commercial aircraft.

42. The process for plating an article of manufacture used in the aerospace industry of claim 41, further comprises the step of providing tanks that hold said cobalt-phosphorous plating solution.

43. The process for plating an article of manufacture used in the aerospace industry of claim 41, further comprises the step of heating said cobalt-phosphorous plating solution to a temperature of about 130 to 140 F.

44. The process for plating an article of manufacture used in the aerospace industry of claim 41, further comprising the step of applying said cobalt-phosphorous-boron coating to said surface at a plating rate of about 0.001 to 0.005 inch/hr.
